(19) United States
(12) Patent Application Publication
(10) Pub. No.: US 2005/0112446 A1
(43) Pub. Date: May 26, 2005

(54) Fuel cell system

(75) Inventors: Tsutomu Yamazaki, Yokosuka-shi (JP); Naohito Yamada, Yokosuka-shi (JP); Masaaki Nakata, Yokohama-shi (JP)

Correspondence Address: FOLEY AND LARDNER;SUITE 500, 3000 K STREET NW, WASHINGTON, DC, 20007, US

(73) Assignee: NISSAN MOTOR CO., LTD.

(21) Appl. No.: 10/976,859

(22) Filed: Nov. 1, 2004

(30) Foreign Application Priority Data
Nov. 5, 2003 (JP) 2003-375657

(51) Int. Cl. H01M 2/14; H01M 2/00; H01M 2/02; H01M 8/18; H01M 8/24

(52) U.S. Cl. 429/38; 429/39; 429/34; 429/19

(57) ABSTRACT

A fuel cell system is disclosed as having a water storage device 2 whose inside is provided with two partition walls 9, 10 to divide the same into three regions R₁, R₂, R₃, and among these, a middle region R₂ is provided with a water guide pipe 11 and a water return pipe 12 by which water is taken out of or returns to the region R₂. Provided on the partition walls 9, 10 are communicating mechanisms 13 through which adjacent regions are brought into fluid communication. The communicating mechanisms 13 have structures that are operative to permit water to be taken out of or to be returned to the region R₂ while blocking outflow of water from the region R₂ to the other regions R₁, R₃.

### BACKGROUND OF THE INVENTION

The present invention relates to a fuel cell system having water circulation means, by which water, stored in a water storage device, is cyclically supplied to a fuel cell, and technology for appropriately taking water out of the water storage device.

As fuel cells for use in fuel cell systems, solid polymer type fuel cells have heretofore been known to be suitable for use in automobiles. The solid polymer type fuel cells refer to structures wherein a solid polymer membrane is interposed as an electrolyte membrane between a hydrogen electrode and an air electrode. With such solid polymer type fuel cells, reaction occurs to cause hydrogen gas to be separated into hydrogen ions and electrons on the hydrogen electrode while oxidant gas reacts with the hydrogen ions and the electrons on the air electrode to create water. When this takes place, the solid polymer membrane functions as an ion conductor to allow the hydrogen ions to transfer through the solid polymer membrane toward the air electrode.

With the solid polymer type fuel cell, the solid polymer membrane is saturated with water to have a function as an ion-conducting electrolyte while having a function to separate hydrogen and oxygen from one another. With the solid polymer type fuel cell having such characteristics, as the solid polymer membrane encounters a shortage of water content, ion resistance increases to cause hydrogen and oxygen to mix with one another, resulting in a difficulty in generating electric power. For this reason, a need arises for supplying the solid polymer membrane with water from an outside to positively humidify the same. To this end, with fuel cell systems in usual practice, attempts have heretofore been made to provide a certain type of humidifying means, for humidifying the solid polymer membrane, including technique for humidifying hydrogen to be supplied.

In usual practice, the humidifying means of such kind has undertaken the form of a circulation channel incorporated in the fuel cell system including a fuel cell and a humidifier while storing humidifying water in a water storage device so as to allow water to be cyclically supplied to these devices from an inside of the water storage device at a demanded flow rate.

Further, in order to maintain the fuel cell at proper temperatures, attempts have heretofore been made to perform cooling using coolant water. The supply and circulation of such coolant water are performed with the water storage device and the circulation channel as set forth above.

Here, it is to be noted that water freezes in the circulation path. It is predicted that a fuel cell powered automobile using the solid polymer type fuel cell, as set forth above, as a prime power source runs in cold areas. When this happens, water inside the circulation channel freezes at temperatures below freezing point, causing the fuel cell to encounter a difficulty in smoothly starting up.

Therefore, Japanese Patent provisional Publication No. 9-147892 proposes a fuel cell system that during start-up of the fuel cell system, water is supplied to a circulation channel and an inside of a fuel cell and during interrupted operation of the fuel cell, water is returned to a water storage device.

### SUMMARY OF THE INVENTION

However, with the fuel cell system applied to a moving object such as a vehicle set forth above, issues arise as described below. If water deviation occurs in the water storage device due to acceleration acting on the vehicle during leaning, turning, accelerating and decelerating motions of the vehicle, probabilities occur in a water pump, by which water is taken out of the water storage device, with an issue of an intake of air, resulting in disturbance in smoothly supplying water to the fuel cell system. If water is not smoothly supplied to the fuel cell system, probabilities occur where the operation of the fuel cell is disturbed.

Therefore, the present invention has an object to provide a fuel cell system wherein even when a vehicle is applied with acceleration like in leaning, turning, accelerating and decelerating motions of the vehicle, water deviation occurring in a water takeoff region of a water storage device can be eliminated to overcome an issue of an intake of air for thereby realizing smooth supply of water.

An aspect of the present invention provides a fuel cell system comprising a fuel cell, a water storage device, having partition walls, by which an inside of the water storage device is divided into a plurality of regions, a water circulating section operative to cyclically supply water, stored in the water storage device, to the fuel cell, and a water purging section operative to permit water in the fuel cell and water in the water circulating section to return to the water storage device during interrupted operation of the fuel cell, wherein the plurality of partition walls include a communicating mechanism operative to permit water to flow into a region closer to a center, among the divided regions, from the other regions while precluding outflow of water from the region closer to the center during movement of water stored in the water storage device.

### BRIEF DESCRIPTION OF THE DRAWINGS

FIG. 1 is a typical view illustrating an essential structure of a fuel cell system of a first embodiment.

FIG. 2 is a typical view illustrating an internal structure of a water storage device equipped in the fuel cell system of the first embodiment.

FIG. 3 is a typical view illustrating an internal structure of a water storage device equipped in a fuel cell system of a second embodiment.

### DETAILED DESCRIPTION OF THE PREFERRED EMBODIMENTS

Hereinafter, fuel cell systems of various embodiments to which the present invention is applied are described below with reference to the accompanying drawings. Also, since the present invention is principally related to a water delivery system, the following embodiments will be described with reference only to a structure related to the water delivery system and description of the other structures is omitted. The present invention is applicable to any of fuel cell systems with respective water delivery systems, and other structures of the fuel cell system may adopt any of structures of the related art.

(First Embodiment)

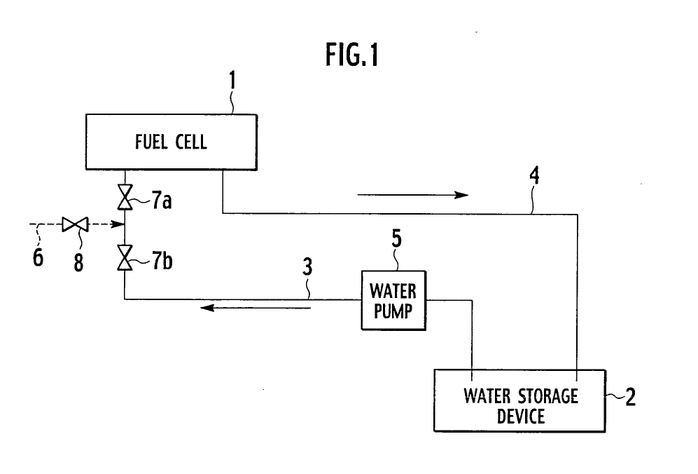

FIG. 1 typically shows one structural example of a water delivery system of a fuel cell system of a first embodiment according to the present invention. The water delivery system is comprised of a fuel cell 1 that generates electric power, a water storage device 2 in which water is stored, a water supply channel 3 and water return channel 4 through which water is cyclically supplied, and a water pump 5 through which water is circulated. Connected to the water supply channel 3 are an airflow line 6 through which a desired pressurized air is introduced during water purging, and valves 7a, 7b by which the water supply channel 3 is blocked during water purging. Also, disposed in the airflow line 6 is a valve 8 that blocks the introduction of pressurized air during normal operation.

With the fuel cell system having such a structure set forth above, during operation of the fuel cell 1, the fuel cell 1 is cyclically supplied with water by means of the water supply channel 3 and the water return channel 4. Also, during interrupted operation of the fuel cell 1, desired pressurized air is introduced through the airflow line 6 to perform water purging, whereupon water, inside the fuel cell 1 and component parts of the circulation channel, is returned to the water storage device 2.

With such a fuel cell system, the water storage device 2 is formed in a substantially cuboid configuration and installed on a vehicle, such as a fuel cell powered automobile, such that the water storage device 2 has a short side orientated in a fore and aft direction of the vehicle and a long side orientated in a lateral direction. Thus, with the water storage device 2 formed in an elongated configuration aligned in a widthwise direction of the vehicle, there is a need for suppressing movement of water inside the water storage device 2 caused by leftward or rightward turning motions of the vehicle.

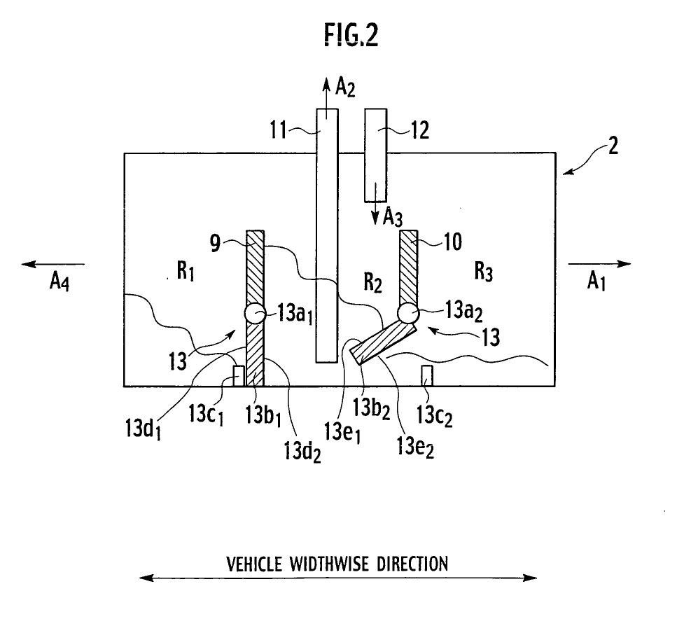

FIG. 2 shows an internal structure of the water storage device 2. With the water storage device 2 formed in an elongated structure in the widthwise direction of the vehicle as set forth above, water deviation occurs as a result of a binding effect (a so-called virtual force) acting in a direction opposite to an accelerating direction (as shown by an arrow A₁) caused by leftward or rightward turning motions of the vehicle and to overcome this issue, the water storage device 2 is provided with two pieces of partition walls 9, 10 to divide an inside of the water storage device 2 into three regions along the widthwise direction of the vehicle. The presence of the two pieces of partition walls 9, 10 allows the inside of the water storage device 2 to be divided into three regions R₁, R₂, R₃.

Among these regions, inserted to a middle region R₂ are a water guide pipe 11, playing a role as a base end portion of the water supply channel 3 forming the water delivery system, which extends in the middle region R₂ toward an area close proximity to a bottom portion thereof and a water return pipe 12, forming a distal end portion of the water return channel 4, which extends to an upper area of the middle region R₂. Water inside the water storage device is drawn by the water pump 5 from the region R₂ through the water guide pipe 11 (as shown by an arrow A₂) and circulated through the circulation channel, whereupon water is returned through the water return pipe 12 back to the region R₂ again (as shown by an arrow A₃).

The partition walls 9, 10 include communicating mechanisms 13, respectively, to selectively provide fluid communication between adjacent regions to admit water flow in a longitudinal direction (along the widthwise direction of the vehicle) of the water storage device 2. The communicating mechanisms 13 are comprised of moveable walls 13b₁, 13b₂, which are rotatable about centers of rotational axes 13a₁, 13a₂, and stoppers 13c₁, 13c₂ that restrict the rotational movements of the moveable walls 13b₁, 13b₂ in the accelerating direction of the vehicle. With effects of the stoppers 13c₁, 13c₂, the moveable walls 13b₁, 13b₂ permit water to flow into the middle region R₂ but blocks the outflow of water from the region R₂ to the other regions R₁, R₃.

A detail of such communicating mechanisms is described below.

Now, as shown in FIG. 2, supposed that the vehicle (i.e., the water storage device 2) is accelerated or decelerated in a direction as shown by the arrow A₁. When this takes place, water inside the water storage device 2 undergoes a binding effect (a so-called virtual force) in a direction (as shown by an arrow A₄) opposite to the accelerating direction (as shown by the arrow A₁). Hereunder, a direction in which the binding effect is applied is referred to as a binding direction. Under such a circumstance, although the moveable wall 13b₁ associated with the partition wall 9 tends to rotate in the binding direction (as shown by the arrow A₄), but can not rotate in the binding direction (as shown by the arrow A₄) due to the effect of the stopper 13c₁ located in a position opposite to a side face 13d₁, facing in the binding direction, of the partition wall 9. In the meanwhile, the moveable wall 13b₂ associated with the partition wall 10 also tends to rotate in the binding direction (as shown by the arrow A₄) and, under such a situation, is not subjected to an effect of the stopper 13c₂ located in a position opposite to a side face 13e₂, facing in the accelerating direction, of the partition wall 10, enabling the moveable wall 13b₂ to freely rotate in the binding direction (as shown by the arrow A₄).

In contrast, it is clear in FIG. 2 that during a phase in which the vehicle (the water storage device 2) is accelerated or decelerated in the direction as shown by the arrow A₄, the communicating mechanisms 13 operate in a manner opposite to that described above, and detailed description of the same is herein omitted.

Also, the communicating mechanisms 13 arranged in such structures set forth above, the water storage device 2 is structured such that closing or opening movements of the moveable walls 13b₁, 13b₂ are performed by power (water pressure) of water that moves inside the water storage device 2 without the use of any particular external energy.

The fuel cell system with such a water delivery system needs to have two functions: one is to satisfy a start-up achievement capability; and the other to take counter measures for an intake of air.

Here, by the term “start-up achievement capability” is meant the capability of the water pump 5 that is available to discharge water at a water circulation rate demanded for the fuel cell system during a phase in which the water storage device 2 reaches a bankfull stage at a halt of the system and during a subsequent phase after the fuel cell system has started up and associated various component parts are filled with water.

In the meanwhile, by the term “an intake of air encountered by the water pump 5” is meant the phenomenon where water deviation occurs inside the water storage device 2 due to the binding effect resulting from the acceleration caused by leaning and turning motions of the vehicle during acceleration or deceleration thereof and a water level exceptionally drops in the region, to which the water guide pipe 11 is inserted, to cause the water pump 5 to encounter the intake of air with a resultant difficulty in maintaining a discharge pressure, and by the term “counter measures for an intake of air” is meant the counter measures to be undertaken to preclude the occurrence of such intake of air.

With the fuel cell system of the presently filed embodiment, the start-up achievement capability can be accomplished by providing the communicating mechanisms 13 provided on the respective partition walls 9, 10.

With the fuel cell system of the presently filed embodiment, during a halt of the system, since introducing pressurized air through the airflow line 6 causes water purging to take place and water inside the fuel cell 1 and the water circulation channel (involving the water supply channel 3 and the water return channel 4 and, additionally, various component parts of the water channels) returns to the water storage device 2, almost no water is present in the water circulation channel and the water storage device 2 comes to a bankfull stage. During start-up, the water pump 6 begins to operate in phase with start-up of the fuel cell system, permitting water to be taken out of the water storage device 2. Water drawn from the water storage device 2 flows through the water supply channel 3, the water return channel 4, the various component parts of the water channels and the fuel cell 1, whereupon water is retuned to the water storage device 2 again.

Accordingly, when water stored in the water storage device 2 is delivered to the water circulation channel during start-up of the system, a water level inside the water storage device 2 drops and the water level inside the water storage device 2 continues to decrease until the water circulation channel is filled with water whereupon water is returned to the water storage device 2. Here, the water level appearing when water begins to be returned to the water storage device 2 is referred to as a “water level after start-up ”.

With the water storage device 2 having a minimum necessary capacity, a big difference occurs between a water level appearing at the halt of the system (subsequent to the purging operation) and a water level after start-up. Since the fuel cell system of the presently filed embodiment takes the form of a structure where the inside of the water storage device 2 is divided into three regions with the partition walls 9, 10 to allow the water pump 5 to draw water from the middle region R₂, the water circulation channel can not be filled with water unless water enters the middle region R₂ from the other regions R₁, R₃, thereby disenabling smooth circulation of water.

Therefore, the fuel cell system of the presently filed embodiment contemplates the provision of the communicating mechanisms 13 provided on the partition walls 9, 10, respectively, thereby enabling water to enter the region R₂ from the other regions R₁, R₃. That is, with the fuel cell system of the presently filed embodiment, as the water level of the region R₂ drops during the start-up of the system, the presence of a difference in head between a water level in the regions R₁, R₃ and a water level in the region R₂ causes a water pressure to act on the moveable walls 13b₁, 13b₂ toward the region R₂ and, hence, the moveable walls 13b₁, 13b₂ are opened inward to admit water flow into the region R₂ from the other regions R₁, R₃. This ensures the water level to be maintained necessary for the region R₂, thereby obtaining a start-up achievement capability.

Next, description is made of the counter measures to be undertaken to prevent the water pump 5 from encountering the intake of air during leaning, turning, accelerating and decelerating motions of a vehicle after start-up of the fuel cell system.

As shown in FIG. 2, due to the binding effect accompanied by the acceleration (as shown by the arrow A₁) resulting from the leaning, turning, accelerating and decelerating motions of the vehicle, the deviation occurs in water stored in the water storage device 2. If the water deviation exceptionally increases, the water level, at which water is drawn, drops below a limit in the intake of air of the water pump 5, resulting in an increased probability for the water pump 5 to encounter the intake of air.

With the fuel cell system of the presently filed embodiment, since the inside of the water storage device 2 is divided into three regions by the partition walls 9, 10, water in the respective regions R₁, R₂, R₃ tends to flow out in the direction (as shown by the arrow A₄) in which the binding effect acts during the leaning, turning, accelerating and decelerating motions of the vehicle. When this takes place, with the communicating mechanism 13 provided on the partition wall 9 located on a side to which water flows from the middle region R₂ in which water takeoff is performed, the rotational movement of the moveable wall 13b₁ is blocked by the stopper 13c₁ located in the position opposite to the side face 13d₁, facing in the binding direction, of the partition wall 9 and no probability occurs for the moveable wall 13b₁ to be opened, thereby blocking the outflow of water from the middle region R₂ to the other region R₁.

In the meanwhile, with the communicating mechanism 13 provided on the partition wall 10 located on a side from which water flows into the middle region R₂, no restriction of the stopper 13c₂, located in a position opposite to the side face 13e₂, facing in the accelerating direction, of the partition wall 10 acts on the rotational movement of the moveable wall 13b₂ and the moveable wall 13b₂ is caused to open due to the movement of water resulting from the turning motion of the vehicle, thereby admitting water flow into the middle region R₂ from the region R₃.

As a result, during the turning motion of the vehicle, almost no water flows out from the middle region R₂ in which water takeoff is performed and, in contrast, water flows into the middle region R₂ from the other region R₃. Thus, even though the deviation occurs in water in the region R₂, it becomes possible for a water level to be ensured to the extent that no probability occurs for the water pump 5 to encounter the intake of air.

As set forth above, with the presently filed embodiment, the water storage device 2 is divided by the partition walls 9, 10 into three regions R₁, R₂, R₃ to allow the water pump 5 to take water out of the region R₂ or to cause water to be returned thereto and the partition walls 9, 10 are provided with respective communicating mechanisms 13 to admit water flow into the region R₂ while blocking the outflow of water from the region R₂ to the other regions R₁, R₃, resulting in a capability of maintaining an appropriate water level in the water takeoff region R₂ in the water storage device 2. Accordingly, the fuel cell system of the presently filed embodiment has a capability of realizing smooth supply of water.

(Second Embodiment)

A fuel cell system of a second embodiment differs from the first embodiment in structures of communicating mechanisms provided in respective partition walls of the water storage device 2. The presently filed embodiment is similar to the first embodiment in other structure and detailed description of the same is herein omitted.

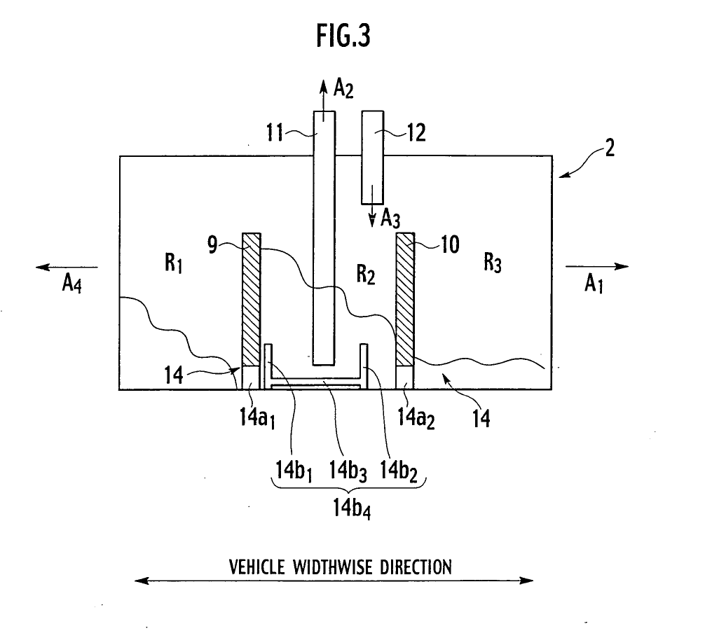

FIG. 3 shows an internal structure of the water storage device 2 that is incorporated in the fuel cell system of the presently filed embodiment. With the water storage device 2, the partition walls 9, 10 are formed with opening portions 14a₁, 14a₂, respectively, and moveable walls 14b₁, 14b₂ are disposed in a middle region R2 to be operative for selectively opening or closing the associated opening portions 14a₁, 14a₂ formed in the partition walls 9, 10. The moveable walls 14b₁, 14b₂ are interconnected to one another through a connecting portion 14b₃ to form a unitary structure as a slider member 14b₄. Thus, the opening portions 14a₁, 14a₂ and the moveable walls 14b₁, 14b₂ form communicating mechanisms 14 that utilize a binding effect, acting in a direction opposite to an acceleration caused during leaning, turning, accelerating and decelerating motions of a vehicle to permit water to flow into the water storage device 2 in the longitudinal direction (along a binding direction).

With the fuel cell system of the presently filed embodiment, a start-up achievement capability is established substantially in the same manner as that of the first embodiment. With the first embodiment, the start-up achievement capability is ensured by an ability of the moveable walls 13b₁, 13b₂ that are opened or closed and, in contrast, the presently filed embodiment ensures the start-up achievement capability through leftward or rightward movements of the slider member 14b₄ as in FIG. 3.

Further, with the water storage device 2 applied with acceleration of the vehicle during leaning, turning, accelerating and decelerating motions thereof, water stored in the water storage device 2 is subjected to the binding effect in the direction opposite to the accelerating direction (as shown by the arrow A₁) and deviation occurs in water inside the water storage device 2 in the binding direction (as shown by the arrow A₄) as shown in FIG. 3. A water pressure, resulting from deviation in water, causes the slider member 14b₄ (with the moveable walls 14b₁, 14b₂) to move in a direction in which water moves. With the communicating mechanism 14, provided on the partition wall 9 located on a side to which water flows from the middle region R₂ in which water takeoff is made, due to the movement of the slider member 14b₄, the opening portion 14a₁, is closed by the moveable wall 14b₁, moved in response to the water pressure, thereby blocking the outflow of water from the middle region R₂ to the other region R₁.

In the meanwhile, with the communicating mechanism 14 provided on the partition wall 10 located on a side from which water flows into the middle region R₂, the opening portion 14a₂ is opened, thereby permitting water to flow into the middle region R₂ from the other region R₃.

As a result, during the turning, accelerating and decelerating motions of the vehicle, almost no water flows out from the region R₂ in which water takeoff is made and, in contrast, water flows into the region R₂ from the other region R₃. Thus, even though the deviation occurs in water in the region R₂, it becomes possible for a water level to be ensured to the extent that no probability occurs for the water pump 5 to encounter the intake of air.

As set forth above, with the fuel cell system of the presently filed embodiment, the water storage device 2 is divided by the partition walls 9, 10 into three regions R₁, R₂, R₃ to allow the water pump 5 to take water out of the region R₂ or to cause water to be returned thereto, like in the first embodiment set forth above and the partition walls 9, 10 are provided with respective communicating mechanisms 14 to admit water flow into the region R₂ from the other regions R₁, R₃ while blocking the outflow of water from the region R₂ to the other regions R₁, R₃, resulting in a capability of maintaining an appropriate water level in the water takeoff region R₂ in the water storage device 2. Accordingly, the fuel cell system of the presently filed embodiment has a capability of realizing smooth supply of water.

As previously noted, although the present invention has been described with reference to the presently filed embodiment in concrete, the present invention is not intended to be limited to these embodiments and various modifications may be possibly made thereto. One alternative may be available for a water storage device to be provided with partition walls, having the same communicating mechanisms as those set forth above, both in areas in a fore and aft direction and widthwise direction of a vehicle and since such an alternative enables to preclude the water pump 5 from suffering the occurrence of an intake of air caused by the deviation in water resulting from acceleration or deceleration of the vehicle or the deviation in water resulting from turning motion of the vehicle, enabling the water storage device 2 to be formed in a configuration closer to a square shape.

Thus, with the fuel cell system of the present invention, as water is taken out of a region, closer to a center of the water storage device, by some suitable means such as the water pump and a water level in this region decreases, water remaining in the other areas flows into the region, closer to the center of the water storage device, through the communicating mechanisms provided on the respective partition walls. When this takes place, the communicating mechanisms are operative to block the outflow of water from the region, closer to the center of the water storage device, to the other regions, promptly eliminating a drop in the water level in the region, closer to the center of the water storage device, due to the takeoff of water therefrom.

Further, with the vehicle applied with acceleration due to leaning, turning, accelerating and decelerating motions of the vehicle, water in the respective regions is subjected to the binding effect accompanied by acceleration and tends to flow in the binding direction (opposite to the accelerating direction). When this takes place, the communicating mechanisms block the outflow of water from the region, closer to the center, to the other regions and water in the region, closer to the center, has a water level necessary for water to be taken out.

As apparent from the foregoing description, with the fuel cell system of the present invention, it becomes possible to minimize the occurrence of water deviation in the water takeoff region even in the presence of acceleration applied under particular conditions such as during leaning, turning, accelerating and decelerating motions of the vehicle. Consequently, with the fuel cell system of the present invention, it becomes possible to address issues with the intake of air encountered by the water pump, making it possible to realize smooth supply of water.

The entire content of Japanese Patent Application No. P2003-375657 with a filing data of Nov. 5, 2003 is herein incorporated by reference.

Although the present invention has been described above by reference to certain embodiments of the invention, the invention is not limited to the embodiments described above and modifications will occur to those skilled in the art, in light of the teachings. The scope of the invention is defined with reference to the following claims.

1. A fuel cell system comprising:
a fuel cell;
a water storage device, having partition walls, by which an inside of the water storage device is divided into a plurality of regions;
a water circulating section operative to cyclically supply water, stored in the water storage device, to the fuel cell; and
a water purging section operative to permit water in the fuel cell and water in the water circulating section to return to the water storage device during interrupted operation of the fuel cell;
wherein the plurality of partition walls include a communicating mechanism operative to permit water to flow into a region closer to a center, among the divided regions, from the other regions while precluding outflow of water from the region closer to the center during movement of water stored in the water storage device.

2. The fuel cell system according to claim 1, wherein:
the communicating mechanism is actuated by a water power applied by water during the movement of water stored in the water storage device.

3. The fuel cell system according to claim 1, wherein:
the communicating mechanism is disposed so as to permit water to enter the water storage device in a longitudinal direction thereof.

4. The fuel cell system according to claim 1, wherein:
the communicating mechanism includes moveable walls rotatable only in directions toward the region closer to the center.

5. The fuel cell system according to claim 1, wherein:
the communicating mechanism includes a slider wall moveable in a direction in which water moves due to the water power occurring during the movement of water stored in the water storage device.

6. A fuel cell system comprising:
a fuel cell;
a water storage device, having partition walls, by which an inside of the water storage device is divided into a plurality of regions;
water circulating means operative to cyclically supply water, stored in the water storage device, to the fuel cell; and
water purging means operative to permit water in the fuel cell and water in the water circulating section to return to the water storage device during interrupted operation of the fuel cell;
wherein the plurality of partition walls include a communicating mechanism operative to permit water to flow into a region closer to a center, among the divided regions, from the other regions while precluding outflow of water from the region closer to the center during movement of water stored in the water storage device.
